(19) United States
(12) Patent Application Publication
(10) Pub. No.: US 2019/0102762 A1
(43) Pub. Date: Apr. 4, 2019

(54) SYSTEM FOR SELF-GENERATION OF DENOMINATIONAL RESOURCES

(71) Applicant: BANK OF AMERICA CORPORATION, Charlotte, NC (US)

(72) Inventors: Jon Robert Wolf, Charlotte, NC (US); Charles R. Liu, San Francisco, CA (US)

(21) Appl. No.: 15/723,619

(22) Filed: Oct. 3, 2017

(51) Int. Cl. G06Q 20/10; G06Q 20/32; G06Q 20/40; G06Q 20/38

(52) U.S. Cl. CPC G06Q 20/1085; G06Q 20/3223; G06Q 20/385; G06Q 20/40; G06Q 20/3278

(57) ABSTRACT

Embodiments of the invention are directed to systems, methods, and computer program products for self-generation of denominational resources. In this way, the system integrates functionality of computer terminals into use mobile devices for self-generation of digital resources for distribution and utilization by the recipient in the form of a token. In this way, the user may digitally extract resources for storage or transmission to a receiver. The digital resource will be treated as a physical resource and are removed from the user's resource account and held as pending.

### BACKGROUND

Computer terminals are commonly used by individuals to perform a variety of activities, specifically distribution of physical resources. With improvements in channel connectivity and communication, connectivity of computer terminals continually improves.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The system integrates functionality of computer terminals onto user mobile devices for self-generation of denomination resources. Specifically, the system may self-generate digital resources for distribution and utilization as currency by the recipient in the form of a token. The user may, utilizing his/her resource distribution account, digitally extract resources to be digitally stored or transmitted to a receiving party for redemption at a later time. The digital resource will be treated as a physical resource and are provided based on removing the resource amount from the user's resource account, and the resource amount of the digital resources are held as pending. The system allows for these digital resources to be legal tender and anonymous as to the account and the user distributing the digital resources.

Furthermore, in some embodiments, the system may be integrated into an automated teller machine (ATM). As such, the ATM may be able to self-generate digital resources with any denomination that the user requests withdraw from his/her resource account. The ATM may transmit the digital resources wirelessly, via near field communication (NFC), or the like to a user mobile device, third party mobile device, or the like. As such, the user may be able to select an odd denomination from the ATM and the ATM may generate the amount of the request via the digital resource distribution.

Embodiments of the invention relate to systems, methods, and computer program products for self-generation of digital resources, the invention comprising: integrating within computer terminals, wherein the integration within the computer terminal allows for self-generation of digital resources and digital resource deployment by a user; authorizing the user at the computer terminal for the self-generation of digital resources; requiring secondary authorization for user access to resource distribution accounts for the self-generation of digital resources and for digital resource deployment; receiving a request from the user via the computer terminal for the self-generation of digital resources, wherein the request comprises a user selected physical denomination for digital resource deployment from one of the resource distribution accounts comprising physical denominations and a channel for the digital resource deployment; generating the digital resources in the denomination requested from the physical denominations of resources in the resource distribution accounts and code for the channel, wherein generating the digital resources further comprises tokenizing the digital resources for deployment; and allowing user transmission of the digital resources to a receiving party.

In some embodiments, the secondary authorization includes authorization for accessing the resource distribution accounts associated with the user, wherein the secondary authorization links the resource distribution accounts for self-generation of digital resources for deployment.

In some embodiments, the invention comprises generating and providing an interface integrated within the computer terminal for user self-generation of digital resources for user distribution to a receiving party.

In some embodiments, resource distribution accounts are linked and integrated within the computer terminals for centralized self-generation of digital resources for user distribution.

In some embodiments, generating the digital resources in the denomination further comprises placing a hold on the denomination one of the resource distribution accounts.

In some embodiments, the channel for the digital resource deployment further comprises a communication channel activated by contact or contactless triggering.

In some embodiments, allowing user transmission of the digital resources to a receiving party further comprises allowing transmission and deployment of the digital resource to the receiving party via the channel.

In some embodiments, the computer terminals further comprise a mobile device, ATM, and computer terminal.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a digital resource self-generation system environment, in accordance with embodiments of the present invention;

FIG. 2 illustrates a representative illustration of a computer terminal associated with the digital resource self-generation system environment, in accordance with embodiments of the present invention;

FIG. 3 illustrates a block diagram of the processing system associated with digital resource self-generation system environment, in accordance with embodiments of the present invention;

FIG. 4 illustrates a block diagram of the user device associated with the digital resource self-generation system environment, in accordance with embodiments of the present invention;

FIG. 5 illustrates an ATM system environment, in accordance with embodiments of the present invention;

FIG. 6 is an interface illustrating an ATM, in accordance with embodiments of the present invention;

FIG. 7 illustrates a process flow for setting up the digital resource self-generation process, in accordance with embodiments of the present invention; and

FIG. 8 illustrates a process of generating and deploying a digital resource, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, an ATM is operated in a public place (e.g., on a street corner, at the doorstep of a private residence, in an open market, at a public rest stop, or the like). In other embodiments, the ATM is additionally or alternatively operated in a place of business (e.g., in a retail store, post office, banking center, grocery store, factory floor, or the like). In accordance with some embodiments, the ATM is owned by the financial institution providing the ATM. In other embodiments, the ATM is owned by one or more third party merchants. In yet other embodiments, the ATM is owned by other financial institutions. While multiple ATM machines are mentioned throughout this discloser, one of ordinary skill in the art will appreciate that one ATM may include all of the features disclosed herein.

As described herein, a “user” is an individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a computer terminal, typically based on successful validation of the user's authentication credentials. In some embodiments, a “user” may be an employee (e.g., a technology operator/technician, an associate, a project manager, an IT specialist, a manager, an administrator, an internal operations analyst, or the like) of the entity or enterprises affiliated with the entity, capable of operating the systems and computer terminals described herein. In other embodiments, a user may be a system or an entity performing one or more tasks described herein.

The term “computer terminal” or “user activity terminal” as used herein may refer to one or more electronic devices that are associated with a third party merchant or vendor. These computer terminals may be one or more point of transaction terminals, point of sale terminals, or the like that facilitate one or more user activities or transactions with the third party. As such, the terms “user activity” or “user transaction” or simply “activity” may refer to financial or non-financial activities, tasks, events or actions. In some embodiments a computer terminal refers to one or more devices that facilitate execution of financial transactions or activities. In this regard, the computer terminals may be point of sale (POS) devices, vending machines, checkout registers, ticket vending machines, automated retail transaction devices, or may comprise technology elements and/or functionality of one or more aforementioned devices, or a suitable combination of the aforementioned devices/apparatuses. In some embodiments the computer terminal refers to devices that facilitate execution of non-financial user activities or transactions, for example, check-in terminals for various industries, for example: hospitality, travel, healthcare and the like, information kiosks and other computer terminals that do not involve a user performing a financial transaction via the computer terminal. In some embodiments the computer terminals enable execution of both financial and non-financial transactions/activities (e.g., a computer terminal may be a suitable combination of any of the aforementioned terminal devices with respect to their features, design and/or function). That said, computer terminals may also refer to portable devices that facilitate financial and/or non-financial transactions, such as personal computers, laptop computers, tablet computers, smartphones, wearable devices, personal digital assistants (PDAs), and other computing devices. In some embodiments, the computer terminals may be owned, operated and/or otherwise associated entities and are installed at suitable locations, such that the user can travel to the location of the computer terminal to perform user activities or execute transactions. In some embodiments, the computer terminals may be owned, operated and/or otherwise associated with the user. In embodiments described herein, performing a user activity or transaction may refer to the initiation, stages during the processing, or completion of a transaction. The computer terminal of the present invention is interactive and is configured to communicate with a user using visual, audio or other means, either directly (e.g., using display devices of the computer terminal) or via suitable devices (e.g., via a user mobile device).

The system integrates functionality of computer terminals onto user mobile devices for self-generation of denomination resources. Specifically, the system may self-generate digital resources for distribution and utilization as currency by the recipient in the form of a token. The user may, utilizing his/her resource distribution account, digitally extract resources to be digitally stored or transmitted to a receiving party for redemption at a later time. The digital resource will be treated as a physical resource and are provided based on removing the resource amount from the user's resource account, and the resource amount of the digital resources are held as pending. The system allows for these digital resources to be legal tender and anonymous as to the account and the user distributing the digital resources.

Furthermore, in some embodiments, the system may be integrated into an automated teller machine (ATM). As such, the ATM may be able to self-generate digital resources with any denomination that the user requests withdraw from his/her resource account. The ATM may transmit the digital resources wirelessly, via near field communication (NFC), or the like to a user mobile device, third party mobile device, or the like. As such, the user may be able to select an odd denomination from the ATM and the ATM may generate the amount of the request via the digital resource distribution.

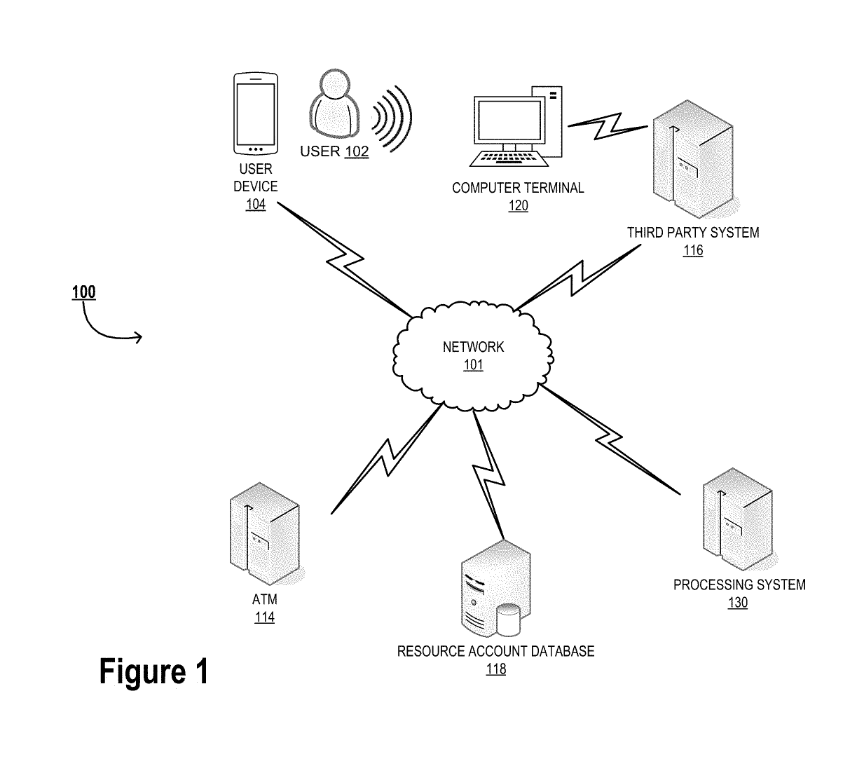

FIG. 1 illustrates a digital resource self-generation system environment 100, in accordance with embodiments of the present invention. As illustrated, the system environment 100 may comprise a computer terminal 120 in operative communication with one or more third party systems 116 and is associated with the third party system 116. The system environment also includes a user 102, a processing system 130, one or more ATM 114, an resource account database 118, and/or other systems/devices not illustrated herein and connected via a network 101. As such, the computer terminal 120 is configured such that the user 102 may link to the computer terminal 120 to perform one or more user activities or transactions by utilizing the computer terminal directly (for example, by physically operating the computer terminal 120 and its interfaces, using input/output devices of the terminal 120, using audio commands, using physical gestures, and the like) and/or via communication between the user device 104 and the terminal 120 (for example, by establishing operative communication channels between the user device 104 and the terminal 120 via a wireless network and interacting with the terminal 120 via the devices and interfaces of the user device 104).

Typically, the processing system 130 and the resource account database 118 are in electronic communication with the third party system 116, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the computer terminal 120). In this regard, the wireless communication channel may further comprise near field communication (NFC), communication via radio waves, communication through the internet, communication via electromagnetic waves and the like.

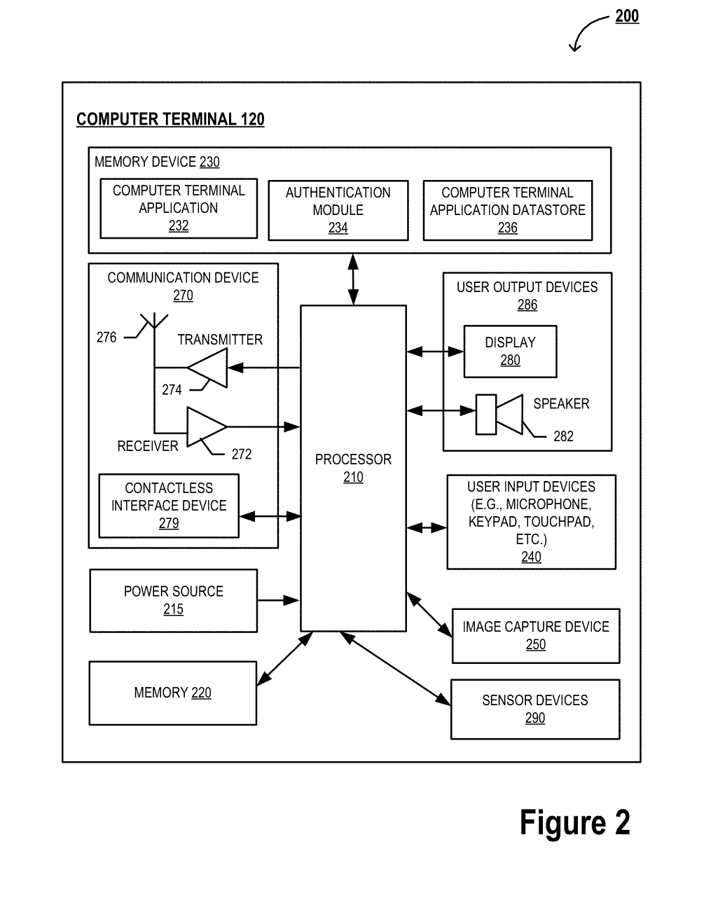

As discussed previously, the computer terminal 120 is configured to facilitate performance of user activities. In some embodiments, the computer terminal 120 is a point of transaction device associated with a merchant configured for uniquely facilitating user activities in accordance with some embodiments, while ensuring the security and privacy of the user. The components of the computer terminal 120, its features and functions will be described in detail through this disclosure and with respect to FIG. 2.

In some embodiments, the computer terminal via the third party system 116 receives signals, images and other data captured by sensor devices and/or the ATM 114, during its execution of user activities. In this regard, in some embodiments, the third party system 116 communicates with, transmits instructions, and/or receives signals from the sensor devices and the ATM 114 directly, via the network 101, typically, in real-time. In some embodiments, the third party system 116 communicates with the sensor devices and the ATM 114 through the processing system 130, typically, in real-time. Analyzing the signals received from the sensor devices and the ATM 114 typically enables the third party system 116, computer terminal 120, the processing system 130, or the devices themselves, to determine user location, determine trigger events (e.g., user approach to the terminal 120, retrieve/identify user authentication credentials from the user and/or the user device, establishing communication with the user device in the vicinity of the terminal, determination of whether the user device comprises an integrated resource transfer application, and the like), capture one or more parameters associated with the environment or physical location of the computer terminal 120, and the like.

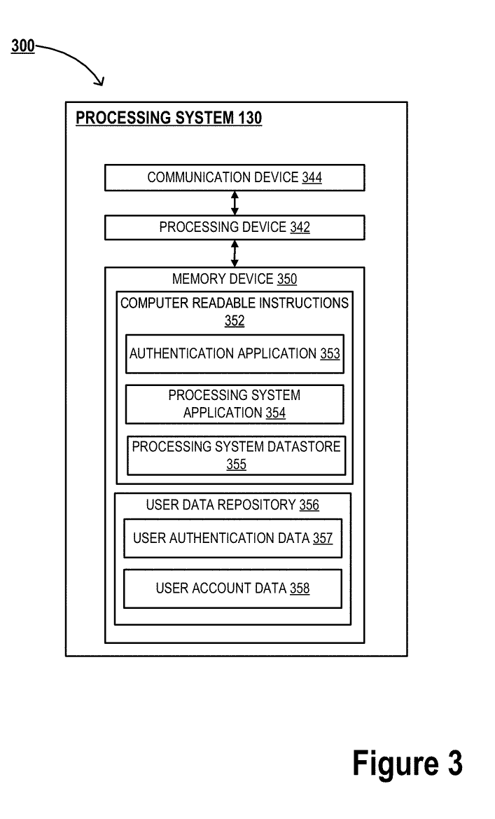

As alluded to previously, the processing system 130 is in operative communication with the computer terminal 120 via linkage through the third party system 116. In some embodiments, processing system 130 is configured to transmit control instructions that are configured to cause the computer terminal 120, the user device 104, the sensor device, and/or the ATM 114 to perform at least a portion of the steps associated with one or more activities. The processing system 130 may be associated with the same entity as the computer terminal 120 or may be associated with another entity. The structure and components of the processing system 130 is described in detail with respect to FIG. 3. The resource account database 118 may comprise authentication credentials associated with the user. The processing system 130 and/or the computer terminal 120 may retrieve the authentication credentials from the authentication database to authenticate the user prior to executing one or more user activities or transactions.

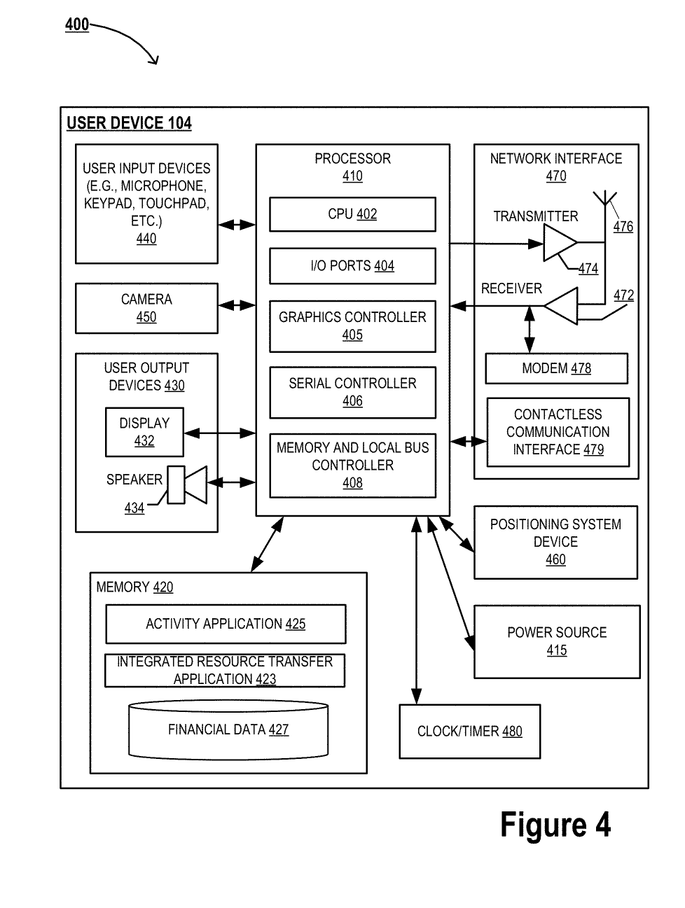

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. As discussed previously, in some embodiments, the computer terminals 120 of the present invention are configured to establish operative communication channels with the user device 104 such that, the user 102 may perform one or more user activities, either entirely or in part, at the terminal 120 by interacting with the user device 104. The user device 104 is described in detail with respect to FIG. 4.

FIG. 2 illustrates a representative illustration of a computer terminal associated with the digital resource self-generation system environment 200 accordance with embodiments of the present invention. In some embodiments, the computer terminal 120 may be another individual and his/her mobile device. In this way, the individual may have a denomination that the user desires. Upon indication, the individual may be able to provide the user with the denomination he/she requests. As such, as used herein in may be understood that a computer terminal 120, merchant device, or point of transaction device may be another individual and his/her mobile device.

As discussed previously, the computer terminal 120 is, in some embodiments, a point of transaction device, point of sale device, or terminal associated with a third party and is configured to facilitate performance of user activities, and is configured to provide real-time interactive sessions for the user 102, using one or more communication channels established via the network 101. The computer terminal 120 typically includes a processing device or a processor 210, memory device 230, storage memory 220 or datastore 220, and a communication device 270. As such, the computer terminal 120, and the processor 210 is particular, is configured to perform at least a portion of the steps of the embodiments described herein, either based on executing computer readable instructions stored in the memory device 230, and/or based on receiving instructions, indications, or signals from other systems and devices such as the processing system 130, the user device 104, sensor devices, ATM 114, the user 102, and/or other systems. In some embodiments, the processing system 130 is configured to transmit control instructions to, and cause the processing device 210 to perform one or more steps of the embodiments presented herein. For example, the processing system 130 may detect a trigger event and transmit an indication to the processing device 210. In response to receiving the control signal from the system 130, the processing device 210 may initiate a presentation of environment parameters.

The processing device 210 may generally refer to a device or combination of devices having circuitry used for implementing the communication and/or logic functions of the computer terminal 120. For example, the processing device 210 may include a control unit, a digital signal processor device, a microprocessor device, and various analog-to-digital converters, digital-to-analog converters, and other support circuits and/or combinations of the foregoing. Control and signal processing functions of the computer terminal 120 may be allocated between these processing devices according to their respective capabilities.

The computer terminal 120 may further include various components/devices in operative communication with and/or controlled by the processor 210, such as user output devices 286, user input devices 240, a network communication interface 279 (such as a contactless interface 279), a power source 215, and the like. Furthermore, in some embodiments, the processor 210 is operatively coupled to and is configured to control other components/devices of the computer terminal 120, such as an image capture device 250, sensor devices 290, and the like. These components and devices are described in detail below.

The memory device 230 and the storage memory 220 may generally refer to a device or combination of devices that store one or more forms of computer-readable media for storing data and/or computer-executable program code/instructions. In some embodiments, the storage memory 220 is integral with the memory device 230. In some embodiments, the memory device 230 comprises a non-transitory, computer readable storage medium. For example, the memory device 230 and/or the storage memory 220 may include any computer memory that provides an actual or virtual space to temporarily or permanently store data and/or commands provided to the processing device 210 when it carries out its functions described herein.

As illustrated by FIG. 2, the memory device 230 typically comprises a computer terminal application 232 (also referred to as a terminal application), an authentication module 234, a computer terminal application datastore 236 stored therein. In some embodiments, the authentication module 234 is integral with the computer terminal application 232. In some embodiments, the computer terminal applications 232 and/or the authentication module 234 may be executable to initiate, perform, complete, and/or facilitate one or more portions of any embodiment described and/or contemplated herein, either independently or in response to receiving control instructions from the processing system 130. In some embodiments, the computer terminal application/module 232 comprises computer readable instructions stored in the memory device 230, which when executed by the processing device 210, are configured to cause the processing device 210 to perform one or more steps of the embodiments presented herein, and/or cause the processing device to transmit control instructions to other components of the terminal 120 and other devices/systems in the network 101 to cause them to perform the steps. Generally, the computer terminal application 232 is executable to receive activity instructions from the user and perform user activities and the various steps described herein. In some embodiments, the computer terminal application 232 comprises a personal digital assistant for interfacing with the user at the terminal. The computer terminal application 232 may be coupled to a computer terminal application datastore 236 for storing application data as the user activity is being performed. The computer terminal application datastore 236 may store the application data temporarily for the predetermined duration of the execution of the activity (such as a memory buffer, or cache memory), or permanently.

The computer terminal 120 may require users to identify and/or authenticate themselves before the computer terminal 120 may initiate, perform, complete, and/or facilitate a user activity. For example, in some embodiments, the computer terminal 120 is configured (and/or the computer terminal application 232 is executable) to authenticate a computer terminal user based at least partially on a computer terminal debit card, smart card, token (e.g., USB token, etc.), username, password, PIN, biometric information, and/or one or more other credentials that the user presents to the computer terminal 120. Additionally or alternatively, in some embodiments, the computer terminal 120 is configured to authenticate a user by using one-, two-, or multi-factor authentication. For example, in some embodiments, the computer terminal 120 requires two-factor authentication, such that the user must provide a valid debit card and enter the correct PIN associated with the debit card in order to authenticate the user to the computer terminal 120. However, either alternatively or in addition to the aforementioned authentication features, the computer terminal 120 may require biometric authentication of the user 102 before initiating, performing, completing, and/or facilitating a user activity.

In some embodiments, the authentication module 234 comprises computer readable instructions that when executed by the processing device 210 cause the processing device to perform one or more functions and/or transmit control instructions to other components or devices to perform one or more authentication steps described herein. These authentication steps typically include requesting authentication credentials from the user via the user output devices 286 (for example, based on determining the desired authorization level for the user activity), activating pertinent sensors and devices for receipt of the credentials (image capture devices 250 for biometric credentials, card reader devices 240 for reading magnetic strips of the user's card(s), contact less interface device 279 for receiving authentication tokens from a user device via NFC channels, and the like), receiving authentication credentials, validating the credentials (for example based on retrieving user credentials from the datastore 236, memory 220, processing system 130 and/or database 118), and the like. That said, as shown, the processing device 210, in turn, is operatively connected to and is also configured to control and cause the communication device 270, the memory device 230, and other components described herein to perform one or more functions, at least in part.

The communication device 270 may comprise a modem 271 (not illustrated), a receiver 272, a server 273 (not illustrated), a transmitter 274, transceiver, and/or another device for communicating with other devices and systems on the network 101. The communication device 270 may further comprise a contact, contactless, wireless and/or wired interface that is configured to establish communication between components of the computer terminal 120, between the computer terminal 120, particularly the processing device 210, and other devices or systems, such as the processing system 130, the user device 104, the resource account database 118, the third party system 116, and the like. In this regard, the communication interface 270 comprises a transmitter 274, a receiver 272, a broadcasting device 276 to transmit and receive signals from corresponding devices via a suitable transmission medium or a communication channel. In some embodiments, the computer terminal 120 is configured to be coupled/connected to other devices and systems via wired communication channels. In other embodiments, the computer terminal 120 is configured to be coupled/connected to other devices via a wireless channel. In this regard, the wireless communication channel may comprise near field communication (NFC), communication via radio waves, communication through the internet, communication via electromagnetic waves and the like. The communication device 270 may further comprise a contactless interface device 279 for establishing contactless communication with other devices, such as the user device 104. Here, the computer terminal 120 may include a transceiver, i.e., one or more antennas and and/or other electronic circuitry, devices, and software, for receiving data when a device is held close to or tapped at a suitable location of the computer terminal 120. Here, radio frequency signals may be transmitted and received in the radio frequency band, such as 13.56 MHz which is generally the frequency for NFC. In one embodiment, the ISO/IEC 14443 standard may define the protocol associated with the data carried by these radio frequency signals. In one embodiment, the transmitter 274 and receiver 272 may transmit and receive radio frequency signals, respectively, from the computer terminal 120 within a distance of up to approximately 25 cm, and from 0-20 cm, such as from 0-15 cm, and 0-10 cm, and the like.

Establishing the communication channels may also include signaling information in accordance with the air interface standard of the applicable cellular system of the wireless telephone network that may be part of the network 101. In this regard, the computer terminal 120 may be configured to operate with one or more air interface standards, communication protocols, modulation types, and access types. By way of illustration, the computer terminal 120 may be configured to operate in accordance with any of a number of first, second, third, and/or fourth-generation communication protocols and/or the like. For example, the computer terminal 120 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The computer terminal 120 may also be configured to operate in accordance with non-cellular communication mechanisms, such as via a wireless local area network (WLAN) or other communication/data networks.

The user interface of the computer terminal 120 may include user input devices 240 and user output devices 286, as illustrated by FIG. 2. The user interface of the computer terminal 120 is typically configured to facilitate the interactive sessions with the user. The user output devices 286 typically include a display 280 (e.g., a liquid crystal display, a touchscreen display, and/or the like) which is operatively coupled to the processing device 210. In some embodiments, where the computer terminal 120 requests the user's signature (if needed), the display may also serve as a touchpad input device to input the user's signature via a stylus. Other output devices may include one or more LEDs or an audio speaker 282, both which may indicate to the user various steps of a user activity. The output devices 286 including the display 280 typically provide instructions and information to the user, regarding the user activity and steps associated with the user activity. The user interface 126 may include any number of user input devices 240 allowing the computer terminal 120 to transmit/receive data to/from the user 102, such as a keypad, keyboard, touch-screen, touchpad, microphone, mouse, joystick, other pointer device, button, soft key, and/or other input device(s). A printer that can print paper receipts may also be incorporated into the computer terminal 120.

As illustrated by FIG. 2, the computer terminal may further comprise an image capture device 250. The image capture device 250 typically comprises cameras and other audio, video and image capture devices. The image capture device 250 is configured to capture images and/or video streams, typically in real-time, of a predetermined proximity area in the vicinity of the computer terminal 120 location. The images and/or video streams may be analyzed by the computer terminal 120 to determine the presence and position of the user, other individuals or objects and their movement in the proximity area, to identify the user for authentication or facial recognition purposes, and the like. In some embodiments, the system is configured to present a customized interface for the user based on identifying the user using facial recognition.

In some embodiments, the computer terminal further comprises sensor devices 290. In some embodiments, the processor 210 communicates with, transmits instructions, and/or receives signals from the sensor devices 290, in real-time for detecting the presence of the users or other individuals, determining user location, capturing authentication credentials for the user, determining parameters associated with the user, determining trigger events, capturing one or more parameters associated with the environment or physical location of the computer terminal 120, and the like. These sensor devices may be contact type sensors that determine the presence of the user or object based on contact, or non-contact type sensors that detect distant users or objects. In some embodiments, the sensor devices 290 of the computer terminal are similar to the sensor devices described previously, for determining the absolute or relative position, location, and proximity of the user, other individuals, or predetermined objects (such as vehicles, and vehicle features like contours of windows), within a predetermined proximity area. For example, the sensor devices 290 may comprise ultrasonic sensors, optical sensors, photoelectric sensors, capacitance sensors, inductive proximity/position sensors, visual capture devices (as described with respect to image/ATM 114), and the associated transducers, transmitter and modulators, described in detail previously.

In some instances, the sensor devices 290 comprise biometric sensors for capturing parameters associated with the user, such as fingerprint scanners, voice recognition sensors, facial recognition sensors, heart rate sensors, user stress level sensors and the like. These biometric sensors 290 are configured to retrieve, receive, analyze and or validate biometric credentials associated with the user. In this regard, the biometric sensors 290 may comprise optical sensors, ultrasonic sensors, and/or capacitance sensors. The biometric sensors may further comprise radio frequency, thermal, pressure, piezo-resistive/piezoelectric, microelectromechanical sensors, and the like.

In some embodiments, the computer terminal 120 may be associated with the system invention. In some embodiments, the computer terminal 120 may be associated with a third party system. In some embodiments, the computer terminal may be an ATM, kiosk, merchant device, or the like. In this way, the processing system 130 may integrate the computer terminal 120 with software and/or hardware for performing the functions described herein.

FIG. 3 illustrates a block diagram of the processing system associated with digital resource self-generation system environment 300, in accordance with embodiments of the present invention. As illustrated in FIG. 3, the processing system 130 may include a communication device 344, a processing device 342, and a memory device 350 having an authentication application/module 353, a processing system application 354 and a processing system datastore 355 stored therein. As shown, the processing device 342 is operatively connected to and is configured to control and cause the communication device 344, and the memory device 350 to perform one or more functions. Furthermore, the processing device 342 is typically configured to control and cause the processing device 210 of the computer terminal 120, the sensor devices, and ATM 114, to perform one or more functions. In some embodiments, the authentication application 353 and/or the processing system application 354 comprises computer readable instructions that when executed by the processing device 342 cause the processing device 342 to perform one or more functions and/or transmit control instructions to the computer terminal 120, the resource account database 118, the third party system 116, the sensor devices, and ATM 114, and/or the communication device 344. It will be understood that the authentication application 353 and/or the processing system application 354 may be executable to initiate, perform, complete, and/or facilitate one or more portions of any embodiments described and/or contemplated herein. The authentication application 353 may comprise executable instructions associated with one or more authentication steps of user activities, and may be embodied within the processing system application 354 in some instances. In some embodiments, the authentication application 353 is similar to the authentication module 234 described previously. The processing system 130 may be owned by, operated by and/or affiliated with financial institutions or other entities. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions. In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like. In some embodiments, the computer terminal 120 may be associated with the system invention. In this way, the processing system 130 may integrate the computer terminal 120 with software and/or hardware for performing the functions described herein.

The communication device 344 may generally include a modem, server, transceiver, and/or other devices for communicating with other devices on the network 101. The network communication device 344 may be a communication interface having one or more communication devices configured to communicate with one or more other devices on the network 101, such as the processing system 130, the sensor devices, and ATM 114, other processing systems, data systems, and the like.

Additionally, referring to processing system 130 illustrated in FIG. 3, the processing device 342 may generally refer to a device or combination of devices having circuitry used for implementing the communication and/or logic functions of the processing system 130. For example, the processing device 342 may include a control unit, a digital signal processor device, a microprocessor device, and various analog-to-digital converters, digital-to-analog converters, and other support circuits and/or combinations of the foregoing. Control and signal processing functions of the system 130 may be allocated between these processing devices according to their respective capabilities. The processing device 342 may further include functionality to operate one or more software programs based on computer-executable program code 352 thereof, which may be stored in a memory device 350, such as the processing system application 354 and the authentication application 353. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 342 may be configured to use the network communication interface of the communication device 344 to transmit and/or receive data and/or commands to and/or from the other devices/systems connected to the network 101.

Furthermore, a “user interface” (not illustrated) may be associated with the processing system 130 and may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user 102 or output data to the user 102. These input and output devices may include a display, mouse, keyboard, button, touchpad, touch screen, microphone, speaker, light, joystick, switch, and/or other customer input/output device for communicating with one or more customers. In some embodiments, the user interface may be provided externally to the processing system, for example on one or more workstations connected to the system 130, the user device 104 or the display device 280 of the computer terminal 120. As another example, the user interface may be provided on the computer terminal 120 that may be controlled by the processing system 130 either directly or via the processing device 210 of the computer terminal 120.

The memory device 350 within the processing system 130 may generally refer to a device or combination of devices that store one or more forms of computer-readable media for storing data and/or computer-executable program code/instructions. For example, the memory device 350 may include any computer memory that provides an actual or virtual space to temporarily or permanently store data and/or commands provided to the processing device 342 when it carries out its functions described herein. The processing system 130 may be used by a third party/entity 116 to interact with the computer terminal 120, based on providing requisite authorization. The processing system 130 may further comprise a user data repository 356 comprising user authentication data 357 and user account data 358. The processing system 130 may utilize the authentication data 357 to validate user authentication credentials. Furthermore, the account data 358 may reflect the current account data of the user.

FIG. 4 illustrates a block diagram of the user device associated with the digital resource self-generation system environment 400, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The mobile device 104 may generally include a processing device or processor 410 communicably coupled to devices such as, a memory device 420, user output devices 430 (for example, a user display device 432, or a speaker 434), user input devices 440 (such as a microphone, keypad, touchpad, touch screen, and the like), a communication device or network interface device 470, a power source 415, a clock or other timer 480, a visual capture device such as a camera 450, a positioning system device 460, such as a geo-positioning system device like a GPS device, an accelerometer, and the like, one or more chips, and the like. The processor 410 may further include a central processing unit 402, input/output (I/O) port controllers 404, a graphics controller 405, a serial bus controller 406 and a memory and local bus controller 408.

The processor 410 may include functionality to operate one or more software programs or applications, which may be stored in the memory device 420. For example, the processor 410 may be capable of operating applications such as the activity application 425, a integrated resource transfer application 423, or a web browser application. The activity application 425 may then allow the mobile device 104 to transmit and receive data and instructions from the computer terminal 120 (for example, via wireless communication or NFC channels), data and instructions from the processing system 130, web content, such as, for example, location-based content and/or other web page content, according to a Wireless Application Protocol (WAP), Hypertext Transfer Protocol (HTTP), and/or the like.

The integrated resource transfer application 423 and the financial data module 427, together may include the necessary circuitry to provide token storage and transmission functionality, transmitter device signal encoding and decoding functionality to the mobile device 104, for secure transmission of financial and authentication credential tokens via the contactless communication interface 479 to the computer terminal 120. That said, in some embodiments the integrated resource transfer application 423 is pre-installed on the user device 104, while in other embodiments, the terminal 120 may transmit and cause installation of the application 423 based on determining that the user device 104 does not comprise the application 423, when the user device is within a pre-determined distance from the terminal 120.

The processor 410 may be configured to use the network interface device 470 to communicate with one or more other devices on a network 101 such as, but not limited to the computer terminal 120 and the processing system 130. In this regard, the network interface device 470 may include an antenna 476 operatively coupled to a transmitter 474 and a receiver 472 (together a “transceiver”), modem 478 and a contactless communication interface 479. The processor 410 may be configured to provide signals to and receive signals from the transmitter 474 and receiver 472, respectively. The signals may include signaling information in accordance with the air interface standard of the applicable BLE standard, cellular system of the wireless telephone network and the like, that may be part of the network 101. In this regard, the mobile device 104 may be configured to operate with one or more air interface standards, communication protocols, modulation types, and access types. By way of illustration, the mobile device 104 may be configured to operate in accordance with any of a number of first, second, third, and/or fourth-generation communication protocols and/or the like. For example, the mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 104 may also be configured to operate in accordance with non-cellular communication mechanisms, such as via a wireless local area network (WLAN) or other communication/data networks. The mobile device 104 may also be configured to operate in accordance Bluetooth® low energy, audio frequency, ultrasound frequency, or other communication/data networks.

The network interface device 470 or communication device 470 may also include a user activity interface presented in user output devices 430 in order to allow a user 102 to execute some or all of processes described herein. The application interface may have access to the hardware, for example, the transceiver, and software previously described with respect to the network interface device 470. Furthermore, the application interface may have the ability to connect to and communicate with an external data storage on a separate system within the network 101. As described above, the mobile device 104 includes a display device 432 having a user interface that includes user output devices 430 and/or user input devices 440. The user output devices 430 may include a display 432 (e.g., a liquid crystal display (LCD) or the like) and a speaker 434 or other audio device, which are operatively coupled to the processor 410. The user input devices 440, which may allow the mobile device 104 to receive data from the user 102, may include any of a number of devices allowing the mobile device 104 to receive data from a user 102, such as a keypad, keyboard, touch-screen, touchpad, microphone, mouse, joystick, other pointer device, button, soft key, and/or other input device(s).

The mobile device 104 may further include a power source 415. Generally, the power source 415 is a device that supplies electrical energy to an electrical load. In some embodiment, power source 415 may convert a form of energy such as solar energy, chemical energy, mechanical energy, and the like, to electrical energy. Generally, the power source 415 in a mobile device 104 may be a battery, such as a lithium battery, a nickel-metal hydride battery, or the like, that is used for powering various circuits, for example, the transceiver circuit, and other devices that are used to operate the mobile device 104. Alternatively, the power source 415 may be a power adapter that can connect a power supply from a power outlet to the mobile device 104. In such embodiments, a power adapter may be classified as a power source “in” the mobile device 104.

The mobile device 104 may also include a memory buffer, cache memory or temporary memory device operatively coupled to the processor 410. Typically, one or more applications 425 and 423, are loaded into the temporarily memory during use. As used herein, memory may include any computer readable medium configured to store data, code, or other information. The memory device 420 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the computer terminal 120 performing one or more steps described herein in conjunction with other devices and systems, either automatically based on executing computer readable instructions of the memory device 230, or in response to receiving control instructions from the processing system 103. In some instances, the system refers to the processing system 103. In some instances, the system refers to the devices and systems on the network environment 100 of FIG. 1. The features and functions of various embodiments of the invention are be described below in further detail.

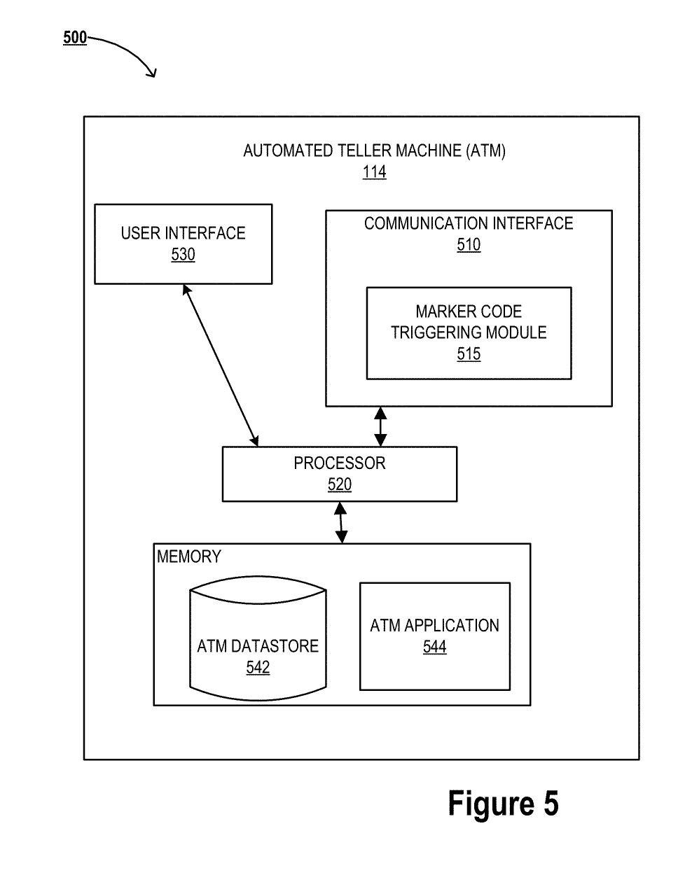

FIG. 5 illustrates an ATM system environment 500, in accordance with embodiments of the present invention. As illustrated in FIG. 5, the ATM 114 includes a communication interface 510, a processor 520, a user interface 530, and a memory 540 having an ATM datastore 542 and an ATM application 544 stored therein. As shown, the processor 50 is operatively connected to the communication interface 510, the user interface 530, and the memory 540.

The communication interface 510 of the ATM may include a marker code triggering module 515. The marker code triggering module 515 is configured to authorize a user via contact, contactless, and/or wireless information communication regarding the pin code or marker code inputted by the user. The marker code triggering module 515 may include a transmitter, receiver, smart card, key card, proximity card, radio frequency identification (RFID) tag and/or reader, and/or the like. In some embodiments, the marker code triggering module 515 communicates information via radio, IR, and/or optical transmissions. Generally, the marker code triggering module 515 is configured to operate as a transmitter and/or as a receiver. The marker code triggering module 515 functions to enable transactions with users using the ATM via identification of the user via physical authentication, contactless authorization, or the like. Also, it will be understood that the marker code triggering module 515 may be embedded, built, carried, and/or otherwise supported in and/or on the ATM 114. In some embodiments, the marker code triggering module 515 is not supported in and/or on the ATM 114, but the marker code triggering module 515 is otherwise operatively connected to the ATM 114 (e.g., where the marker code triggering module 515 is a peripheral device plugged into the ATM 114 or the like).

The communication interface 510 may generally also include a modem, server, transceiver, and/or other device for communicating with other devices and systems on a network.

The user interface 530 of the ATM 114 may include a display (e.g., a liquid crystal display, a touchscreen display, and/or the like) which is operatively coupled to the processor 520. The user interface 530 may include any number of other devices allowing the ATM 114 to transmit/receive data to/from a user, such as a keypad, keyboard, touch-screen, touchpad, microphone, mouse, joystick, other pointer device, button, soft key, and/or other input device(s).

As further illustrated in FIG. 5, the memory 540 may include ATM applications 544. It will be understood that the ATM applications 544 can be executable to initiate, perform, complete, and/or facilitate one or more portions of any embodiment described and/or contemplated herein. Generally, the ATM application 544 is executable to receive transaction instructions from the user and perform typical ATM functions, as appreciated by those skilled in the art. In some embodiments of the invention, the ATM application is configured to access content, such as data stored in memory, for example in the ATM datastore 542, or a database in communication with the ATM 114 and may transfer the content to the external apparatus if the external apparatus is configured for ATM communication.

Of course, the ATM 114 may require users to identify and/or authenticate themselves to the ATM 114 before the ATM 114 will initiate, perform, complete, and/or facilitate a transaction. For example, in some embodiments, the ATM 114 is configured (and/or the ATM application 544 is executable) to authenticate an ATM user based at least partially on an ATM debit card, smart card, token (e.g., USB token, or the like), username, password, pin, biometric information, and/or one or more other credentials that the user presents to the ATM 114. Additionally or alternatively, in some embodiments, the ATM 114 is configured to authenticate a user by using one-, two-, or multi-factor authentication. For example, in some embodiments, the ATM 114 requires two-factor authentication, such that the user must provide a valid debit card and enter the correct pin associated with the debit card in order to authenticate the user to the ATM 114. However, in some embodiments, the user may access the ATM 114 and view or receive content that may be transferred to/from the ATM 114.

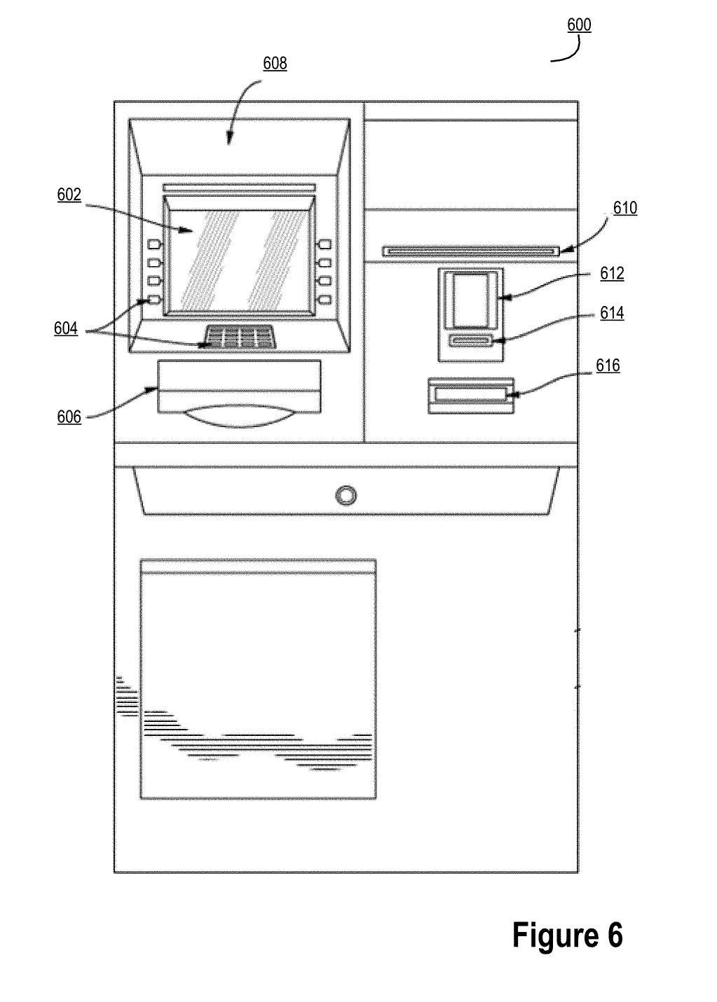

FIG. 6 is an interface illustrating an ATM 600, in accordance with embodiments of the present invention. While an ATM is presented in FIG. 6, the device may be an ATM, transaction device, kiosk, terminal, merchant location, online interface, or the like. FIG. 6 provides a representative illustration of an ATM, in accordance with one embodiment of the present invention. In some embodiments, the representative ATM may comprise features similar to features found on a standard ATM. The lighting means 608 may be located above the display 602 that may provide a customer light for use during an ATM transaction. Of note, the display 602 may be vertically adjusted or horizontally adjusted along tracks or the like to position itself across the entire ATM. While currently illustrated in the upper left corner of the ATM, one will appreciate that the display may move to the right upper corner or below to the lower corners of the ATM and/or anywhere in between if necessary. The lighting means 608 may also be moved with the ATM display 602 and provide the customer a safety mechanism to aid in the ATM transaction.

The cash receptacle 606 may provide the customer means for receiving cash that the customer requests for withdraw through the ATM transaction. In some embodiments, the ATM may also include a contactless identification sensor 612, a contact identification sensor 614 such as a debit or ATM card acceptor, a keypad 604, a receipt receptacle 610, and a deposit receptacle 616. In some embodiments, the contactless identifier 612 and/or the contact identifier 614 may provide the ATM means of receiving identification from the customer. The customer may provide contactless or contact identification means through the ATM. The identification means using a contactless or contact identifications may be provided through several mechanisms, including, but not limited to, biometric identification, laser identification, magnetic strip identification, barcode identification, radio frequency (RF), a character recognition device, a magnetic ink, code readers, wireless communication, debit card scanning, ATM card scanning, and/or the like. The authentication from the contactless identifier of contact identifier may be read by the ATM application. After the authentication has been read, the system may provide the authentication to the financial institution to authorize an ATM transaction.

In some embodiments, the keypad 604 may provide for identification of the customer for use of the ATM. The keypad 604 may provide the customer means for inputting a pin number identification. In this way, the keypad 604 enables the customer to input his pin number into the ATM. In some embodiments, the pin number inputted on the keypad 604 may be read by the system. After the pin number has been read, the ATM may receive the pin number and provide authentication of the identification with the financial institution system.

The display 602 provides a means for displaying information related to the customer's ATM transaction. Display information may be, but is not limited to display of interfaces, such as the start-up interface and an ATM transaction interface. In some embodiments, the display 602 is a touch screen display module.

It is understood that the servers, systems, and devices described herein illustrate one embodiment of the invention. It is further understood that one or more of the servers, systems, and devices can be combined in other embodiments and still function in the same or similar way as the embodiments described herein.

The system integrates functionality of computer terminals onto user mobile devices for self-generation of denomination resources. Specifically, the system may self-generate digital resources for distribution and utilization as currency by the recipient in the form of a token. The user may, utilizing his/her resource distribution account, digitally extract resources to be digitally stored or transmitted to a receiving party for redemption at a later time. The digital resource will be treated as a physical resource and are provided based on removing the resource amount from the user's resource account, and the resource amount of the digital resources are held as pending. The system allows for these digital resources to be legal tender and anonymous as to the account and the user distributing the digital resources.

Furthermore, in some embodiments, the system may be integrated into an automated teller machine (ATM). As such, the ATM may be able to self-generate digital resources with any denomination that the user requests withdraw from his/her resource account. The ATM may transmit the digital resources wirelessly, via near field communication (NFC), or the like to a user mobile device, third party mobile device, or the like. As such, the user may be able to select an odd denomination from the ATM and the ATM may generate the amount of the request via the digital resource distribution.

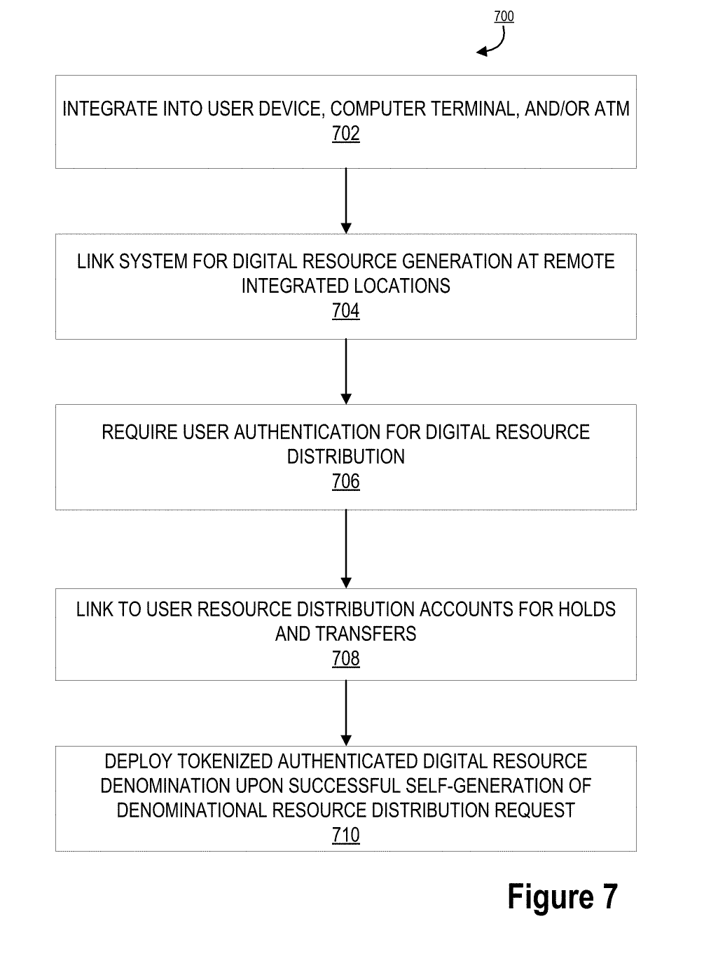

FIG. 7 illustrates a process flow for setting up the digital resource self-generation process 700, in accordance with embodiments of the present invention. As illustrated in block 702, the process 700 is initiated by integrating into a user device, computer terminal, and/or ATM. As described in detail above the user device, computer terminal, and/or ATM may be accessed via communication device over a network. In this way, in some embodiments, the system may integrate into a user device to allow the user device to self-generate digital resource distribution tokens for presentation to a receiving party. In some embodiments, the system may integrate into a computer terminal to allow the computer terminal to self-generate digital resource distribution tokens for presentation to a receiving party. In some embodiments, the system may integrate into an ATM to allow the ATM to self-generate digital resource distribution tokens for presentation to a receiving party.

Next, as illustrated in block 704, upon integration of the system applications within the devices, the system a may link for digital resource generation at the remote integrated locations. In this way, the system applications at the remote computer terminal devices, such as the user device, ATM, or computer terminal may communicate with the central system for linkage of the devices to the central system for self-generation and deployment of digital resources.

As illustrate in block 706, the process 700 continues by requiring user authentication for digital resource distribution. This authentication is set up by the user and may be different based on the device the user is transacting from. For example, if the user is utilizing an ATM for the self-generation of digital resources, the user may be authorized via PIN input in combination with contact or contactless authentication discussed above. If the user is utilizing a mobile device, a password, PIN, and/or biometric authentication may be required for self-generation of digital resources. In this way, the user will authorize into the system and the account associated with the resources the user desired to transfer via the self-generation of digital resources. In this way, the system requests a user authentication, such as a user password, biometric screen, or the like. Furthermore, as a secondary authentication, the system identifies the user authentication for accessing the user account associated with the resources the user desires to utilize for the self-generation of digital resources for distribution to a third party.

Once the user provides the authentication information, the system may link to the appropriate user resource distribution accounts for transferring of the resources, as illustrated in block 708. In this way, the system may link to one or more financial institutions housing the user resource distribution accounts to withdraw the funds for the digital resource distribution and hold the account upon distribution.

As illustrated in block 710, the process 700 is completed upon deploying tokenized authenticated digital resource denominations upon receiving a successful self-generation of denominational resource distribution request.

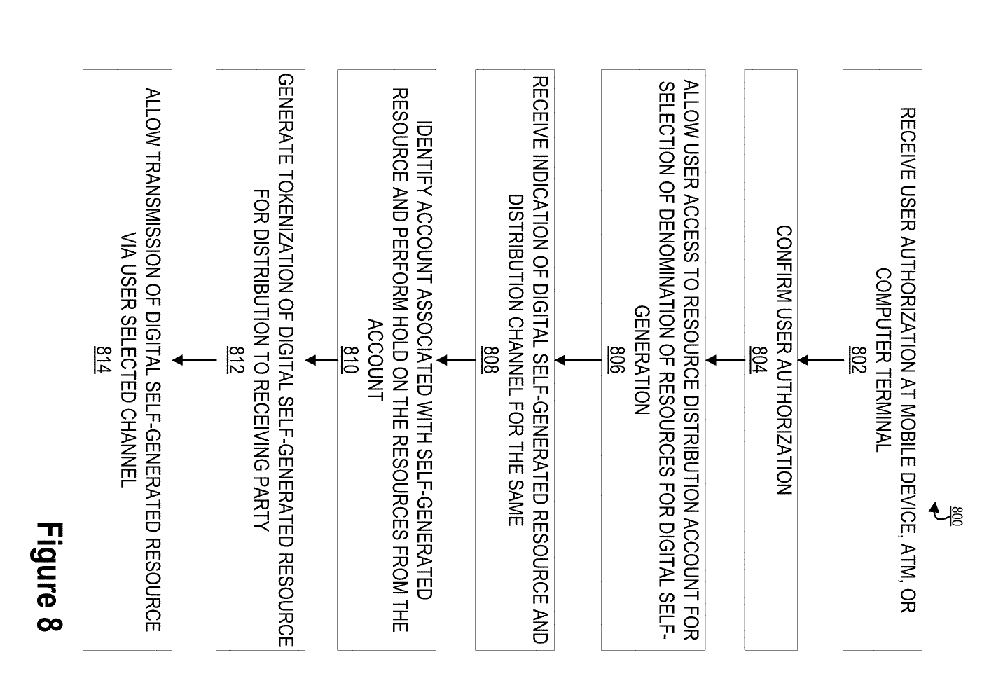

FIG. 8 illustrates a process of generating and deploying a digital resource 800, in accordance with embodiments of the present invention. Once the system has been integrated into a mobile device, ATM, and/or computer program, the process 800 may be initiated by receiving a user authorization at a mobile device, ATM, or computer terminal, as illustrated in block 802. In this way, the user may input one or more authorization passwords, biometrics, contactless authorization, or the like. Next, as illustrated in block 804, the system may confirm the user authorization for access to the self-generation of denominational resources system. As such, allowing the user to gain access to the system for user self-generation of resources. This access may be from a user device, ATM, and/or computer terminal.

Upon user authorization into the system, the user may be allowed access to a resource distribution account for selection of denomination of resources for digital self-generation. In some embodiments, the user may be allowed access to the user's resource distribution account upon secondary authorization into the financial institution associated with the resource distribution account. In this way, the user may be authorized into the system via the mobile device, ATM, and/or computer terminal and a secondary authorization into the user's resource distribution account.

Once authorized into the system and into the user's resource distribution account via a financial institution or the like, the process 800 continues by the user inputting a request for the generation of a new digital self-generated resource and a specific channel for the distribution. As illustrated in block 808, the system may receive an indication of the digital self-generated resource and the selected resource distribution channel selected for the same. In some embodiments, the channel may transmission of the digital resource distribution to a receiving party via a network. In some embodiments, the user may be able to print or otherwise physically distribute the digital resource distribution. In some embodiments, the digital resource distribution may be transmitted from the user to a receiving party via digital contact communication (such as touch or the like), contactless communication (such as NFC or the like), or the like type of digital communication.

Next, as illustrated in block 810, the process continues by identifying the account associated with the self-generated resource distribution request and perform a hold on the funds from the account. In this way, the self-generated resource distribution may be treated as a certified check, cash, or the like. Thus, the resource amount from the user account will be held to match the amount requested in the self-generated digital resource distribution.

As illustrated in block 812, the process 800 continues by generating a tokenization of the digital self-generated resource for distribution to the receiving party. In this way, the system may generate the digital resource in the appropriate currency for communication to the receiving party via the appropriate user selected channel. Finally, as illustrated in block 814, the process 800 ends by allowing for transmission of the digital self-generated resource via the selected channel.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for self-generation of digital resources, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
integrate within computer terminals, wherein the integration within the computer terminal allows for self-generation of digital resources and digital resource deployment by a user;
authorize the user at the computer terminal for the self-generation of digital resources;
require secondary authorization for user access to resource distribution accounts for the self-generation of digital resources and for digital resource deployment;
receive a request from the user via the computer terminal for the self-generation of digital resources, wherein the request comprises a user selected physical denomination for digital resource deployment from one of the resource distribution accounts comprising physical denominations and a channel for the digital resource deployment;
generate the digital resources in the denomination requested from the physical denominations of resources in the resource distribution accounts and code for the channel, wherein generating the digital resources further comprises tokenizing the digital resources for deployment; and
allow user transmission of the digital resources to a receiving party.

2. The system of claim 1, wherein the secondary authorization includes authorization for accessing the resource distribution accounts associated with the user, wherein the secondary authorization links the resource distribution accounts for self-generation of digital resources for deployment.

3. The system of claim 1, further comprising generating and providing an interface integrated within the computer terminal for user self-generation of digital resources for user distribution to a receiving party.

4. The system of claim 1, wherein resource distribution accounts are linked and integrated within the computer terminals for centralized self-generation of digital resources for user distribution.

5. The system of claim 1, wherein generating the digital resources in the denomination further comprises placing a hold on the denomination one of the resource distribution accounts.

6. The system of claim 1, wherein the channel for the digital resource deployment further comprises a communication channel activated by contact or contactless triggering.

7. The system of claim 1, wherein allowing user transmission of the digital resources to a receiving party further comprises allowing transmission and deployment of the digital resource to the receiving party via the channel.

8. The system of claim 1, wherein the computer terminals further comprise a mobile device, ATM, and computer terminal.

9. A computer program product for self-generation of digital resources with at least one non-transitory computer-readable medium having computer-readable program code portions embodied therein, the computer-readable program code portions comprising:
an executable portion configured for integrating within computer terminals, wherein the integration within the computer terminal allows for self-generation of digital resources and digital resource deployment by a user;
an executable portion configured for authorizing the user at the computer terminal for the self-generation of digital resources;
an executable portion configured for requiring secondary authorization for user access to resource distribution accounts for the self-generation of digital resources and for digital resource deployment;
an executable portion configured for receiving a request from the user via the computer terminal for the self-generation of digital resources, wherein the request comprises a user selected physical denomination for digital resource deployment from one of the resource distribution accounts comprising physical denominations and a channel for the digital resource deployment;
an executable portion configured for generating the digital resources in the denomination requested from the physical denominations of resources in the resource distribution accounts and code for the channel, wherein generating the digital resources further comprises tokenizing the digital resources for deployment; and
an executable portion configured for allowing user transmission of the digital resources to a receiving party.

10. The computer program product of claim 9, wherein the secondary authorization includes authorization for accessing the resource distribution accounts associated with the user, wherein the secondary authorization links the resource distribution accounts for self-generation of digital resources for deployment.

11. The computer program product of claim 9, further comprising an executable portion configured for generating and providing an interface integrated within the computer terminal for user self-generation of digital resources for user distribution to a receiving party.

12. The computer program product of claim 9, wherein resource distribution accounts are linked and integrated within the computer terminals for centralized self-generation of digital resources for user distribution.

13. The computer program product of claim 9, wherein generating the digital resources in the denomination further comprises placing a hold on the denomination one of the resource distribution accounts.

14. The computer program product of claim 9, wherein the channel for the digital resource deployment further comprises a communication channel activated by contact or contactless triggering.

15. The computer program product of claim 9, wherein allowing user transmission of the digital resources to a receiving party further comprises allowing transmission and deployment of the digital resource to the receiving party via the channel.

16. A computer-implemented method for self-generation of digital resources, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
integrating within computer terminals, wherein the integration within the computer terminal allows for self-generation of digital resources and digital resource deployment by a user;
authorizing the user at the computer terminal for the self-generation of digital resources;
requiring secondary authorization for user access to resource distribution accounts for the self-generation of digital resources and for digital resource deployment;
receiving a request from the user via the computer terminal for the self-generation of digital resources, wherein the request comprises a user selected physical denomination for digital resource deployment from one of the resource distribution accounts comprising physical denominations and a channel for the digital resource deployment;
generating the digital resources in the denomination requested from the physical denominations of resources in the resource distribution accounts and code for the channel, wherein generating the digital resources further comprises tokenizing the digital resources for deployment; and
allowing user transmission of the digital resources to a receiving party.

17. The computer-implemented method of claim 16, wherein the secondary authorization includes authorization for accessing the resource distribution accounts associated with the user, wherein the secondary authorization links the resource distribution accounts for self-generation of digital resources for deployment.

18. The computer-implemented method of claim 16, further comprising generating and providing an interface integrated within the computer terminal for user self-generation of digital resources for user distribution to a receiving party.

19. The computer-implemented method of claim 16, wherein resource distribution accounts are linked and integrated within the computer terminals for centralized self-generation of digital resources for user distribution.

20. The computer-implemented method of claim 16, wherein generating the digital resources in the denomination further comprises placing a hold on the denomination one of the resource distribution accounts.
